(19) United States
(12) Patent Application Publication
(10) Pub. No.: US 2015/0205045 A1
(43) Pub. Date: Jul. 23, 2015

(54) FUSION SPLICER HAVING ADDED OPTICAL FIBER INSPECTION FUNCTION

(71) Applicant: ILSINTECH CO., LTD., Daejeon (KR)

(72) Inventor: Chan Soul Park, Daejeon (KR)

(21) Appl. No.: 14/425,290

(22) PCT Filed: Feb. 18, 2013
(86) PCT No.: PCT/KR2013/001243

§ 371 Date: Mar. 2, 2015

(30) Foreign Application Priority Data
Sep. 3, 2012 (KR) 10-2012-0097200

(51) Int. Cl. G02B 6/255; G01M 11/00

(52) U.S. Cl. CPC G02B 6/2553; G01M 11/30

(57) ABSTRACT

The present invention relates to an optical fiber fusion splicer and, more particularly, to a fusion splicer having an added optical fiber inspection function to which a power meter function is added in order to determine whether a connection is normal after optical fiber fusion splicing so that the processes of optical fiber fusion splicing and inspection of whether the fusion splicing is successful can be handled with one apparatus and not two as is done in the related art. The fusion splicer having the added optical fiber inspection function includes: an adapter which is connected to the input end of an optical fiber which is fused with the optical fiber fusion splicer in order to have a fusion splicing section for receiving an optical input from the output end of the optical fiber; and a control unit which is connected to the adapter so as to calculate the optical loss ratio of the input end of the optical fiber as compared to the optical signal strength of the output end of the optical fiber. Also, the fusion splicer having the added optical fiber inspection function can further include a monitor which is connected to the control unit to display the optical loss ratio. A set loss ratio according to the length between the input end and the output end of the optical fiber is stored in advance, and the control unit further has a function of determining an abnormal connection when the set loss ratio is exceeded and of determining a normal connection when the set loss ratio is not exceeded. The monitor is configured to display whether the connection is successful or has failed based on the determination of the control unit.

### TECHNICAL FIELD

The present invention relates to an optical fiber fusion splicer and, more particularly, to a fusion splicer having an added optical fiber inspection function to which a power meter function is added in order to determine whether a connection is normal after optical fiber fusion splicing so that the processes of optical fiber fusion splicing and inspection of whether the fusion splicing is successful can be handled with one apparatus and not two as is done in the related art.

### BACKGROUND ART

FTTx technology includes a Fiber-To-The-Building (FTTB) type, an FTTCab type, a Fiber-To-The-Curb (FTTC), and a Fiber-To-The-Home (FTTH) type. The FTTB type is to lay an optical fiber to the main distribution frame installed in an apartment house or buildings and to use metal cable to each subscriber's house. The FTTCab type is to lay the optical fiber to a cabinet which contains communication equipments installed in a position which is several kilometers away from the subscriber's house. The FTTC type is to lay the optical fiber to a telegraph pole or street near the subscriber's house and to use the existing metal cable to each subscriber's house from the laying position. The FTTH type is to lay directly the optical fiber to the subscriber's house.

The FTTH type is to directly push the optical cable into the subscriber's house and is referred to as Fiber-To-The-Premises (FTTP).

The FTTH type is to push the optical cable into the main distribution frame (MDF) installed in buildings or an apartment house like a mansion, etc., and is to use the following types to each subscriber's house.
Wired LAN wiring (Internet)
VDSL or HomePAN using existing telephone lines
Using existing antenna wiring (coaxial cable) and a cable modem which is used within a section (DOCSIS, c.LINK, etc)
PLC using an existing electric lamp wire and distribution line.

The FTTCab type and FTTC type are to push the optical cable into the street curb in case of a common duct, etc., (information box, etc.) and into the telephone pole in case of an overhead line, and are to use the following type to each house.
Communication between the antenna installed in the subscriber's house and the wireless base station installed near the wireless apartment house
Optical wireless communication

Meanwhile, it is necessary that the end of the FTTH should be connected to the optical fiber connector and the connection should be examined. That is, it is required to examine whether the connector is normally connected or not after the connector connection. A fusion splicer is responsible for the connection, and a power meter is responsible for the examination. The fusion splicer and the power meter will be briefly described as follows with reference to FIGS. 1 and 2.

As shown in FIG. 1, the fusion splicer 200 includes a body 210 which embeds or protects each of the components constituting the fusion splicer 200, a splicing part 220 for connecting two optical fibers, a fusion part 230 which fits a reinforcing sleeve into the optical fiber connected by the splicing part 220 and then fuses, a controller 240 which controls the electrical components of the fusion splicer 200, a monitor 250 which displays of the state of the fusion splicer 200, an input unit 260 for operating or inputting, and a power source 270 which supplies electric power to the electrical components of the fusion splicer 200. The structure of the fusion splicer 200 has been disclosed in numerous documents.

As shown in FIG. 2, a power meter 300 includes a body 310 which embeds or protects each of the components constituting the power meter 300, a controller 320 which controls the electrical components out of the components constituting the power meter 300, a monitor 330 which displays the state (e.g., the measured value of the optical reception rate, etc) of the power meter 300, an adaptor 340 for connecting the optical fiber connector, an input unit 350 for operating or inputting, and a power source 360 which supplies electric power to the electrical components of the power meter 300.

The fusion splicer 200 and power meter 300 are independent of each other. Therefore, each of the fusion splicer 200 and power meter 300 should be used to connect the end of the FTTH with the optical fiber connector and to examine the connection. As a result, it is troublesome for the worker to carry both the fusion splicer 200 and power meter 300.

Also, despite the fact that the fusion splicer 200 and power meter 300 are used in the same workspace (the end of the FTTH) and have a lot of repetitive components (power source, monitor, body, controller, etc), the fusion splicer 200 and power meter 300 are in the form of two devices. As a result, this is unproductive and inefficient.

### PRIOR DOCUMENT

(Patent document 1) Korean Patent Number 10-0951427 (Announcement Date: Apr. 7, 2010)

(Patent document 2) Korean Patent Number 10-0459998 (Announcement Date: Dec. 4, 2004)

### DISCLOSURE

### Technical Problem

The present invention intends to add the following functions to the optical fiber fusion splicer.

\hat{1} Function to fusion splice the optical fiber by the optical fiber fusion splicer and then to check the loss rate due to the fusion splicing portion

\hat{2} Function to fusion splice the optical fiber by the optical fiber fusion splicer and then to check with the naked eye whether or not the fusion splicing portion is normal

### Technical Solution

To accomplish the above-described objective of the present invention, a fusion splicer having an added optical fiber inspection function includes: an adaptor which is connected to an input terminal of the optical fiber and receives light from an output terminal of the optical fiber, wherein the input terminal is fused to the optical fiber fusion splicer and has a fusion splicing part; and a controller which is connected to the adaptor and calculates an optical loss rate of the input terminal of the optical fiber compared to an optical signal intensity of the output terminal of the optical fiber. Hereafter, the embodiment of the present invention will be more clearly understood by the following specific details.

### Advantageous Effects

According to the embodiment of the present invention, a power meter function is added to the fusion splicer and the adaptor is inserted into the fusion splicer, and then the rest of the PCB board, controller, monitor, power source and the like, which are for performing the power meter function, are integrated and used with the PCB board, controller, monitor, power source of the fusion splicer. As a result, the devices can be efficiently used.

Also, the PCB board, controller, monitor, power source and the like, which are repetitive components of the fusion splicer and the power meter, are integrated and used, so that the size and cost of the device can be significantly reduced and the unnecessary waste of resources can be prevented.

Also, in the past, the fusion splicer and the power meter should be carried in order to work at the end of the FTTH. However, in the embodiment of the present invention, it is enough as long as only one integrated fusion splicer is carried.

### BRIEF DESCRIPTION OF DRAWINGS

FIG. 1 shows a conventional optical fiber fusion splicer;

FIG. 2 shows a conventional power meter;

FIG. 3 is a schematic view of an optical fiber fusion splicer according to an embodiment of the present invention;

FIG. 4 shows a connection relationship of a main part of the optical fiber fusion splicer according to the embodiment of the present invention;

FIGS. 5 and 6 are views showing an operation relationship of an adaptor, i.e., the main part of the optical fiber fusion splicer according to an embodiment of the present invention;

FIG. 7 is a schematic view of an optical fiber fusion splicer according to another embodiment of the present invention;

FIG. 8 is a view showing an operation relationship of a light source, i.e., the main part of the optical fiber fusion splicer according to the another embodiment of the present invention;

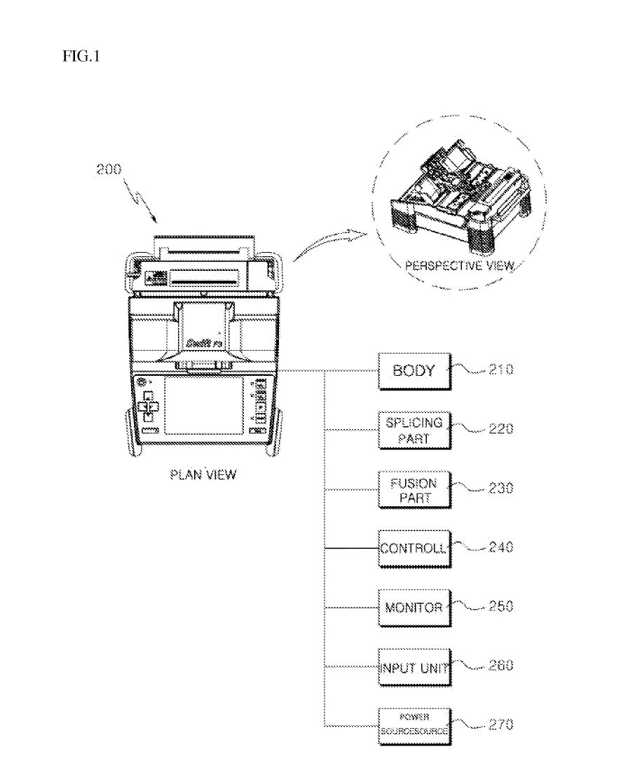

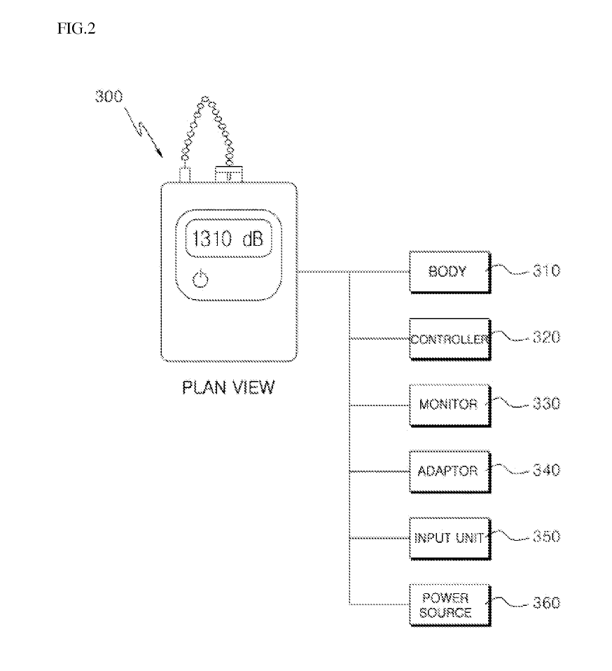

### MODE FOR INVENTION

The present invention relates to an optical fiber fusion splicer and, more particularly, to a fusion splicer having an added optical fiber inspection function to which a power meter function is added in order to determine whether a connection is normal after optical fiber fusion splicing so that the processes of optical fiber fusion splicing and inspection of whether the fusion splicing is successful can be handled with one apparatus and not two as is done in the related art.

Prior to the description of the fusion splicer having an added optical fiber inspection function according to the embodiment of the present invention, optical fiber splicing will be described.

The optical fiber splicing may be distinguished as optical fiber core wire splicing and sheath jointing. These technologies are required to equalize the reliability of the splicing part with that of the optical fiber and to have excellent efficiency, workability and economical efficiency. The optical fiber core wire splicing is to bond the optical fiber permanently. The sheath jointing is to join a tension wire, cable sheath, etc., and can be made by using the fusion splicer, and the like.

Here, the optical fiber core wire splicing includes fusion splicing which fuses and splices the optical fiber by arc discharge and mechanical splicing which mechanically splices the optical fiber by V-groove method. There is a difference in the work processes between the fusion splicing and the mechanical splicing in accordance with the kind of the core wire.

In the sheath jointing, the end processing of the optical fiber and the connection method of the optical fiber are changed according to the structure of the optical fiber to be spliced and the structure of a splice box to be used. Therefore, in order to enhance the reliability of the optical fiber splicing part, the sheath jointing is made in accordance with the work process suitable for the structure of the optical fiber and the splice box.

Before splicing the optical fiber, information on the specification of the optical fiber to be spliced should be collected and the same optical fibers should be spliced to each other. Also, the optical fiber to be spliced should be protected from water or moisture and should not be affected by a tension and winding, etc.

The optical fiber splicing is distinguished as a linear splice which interconnects the optical fibers without diminishing the optical fiber core wire in accordance with the form in which the optical fiber is spliced and a branch splice which distributes the optical fiber core wire in accordance with demand generation. The branch splice includes a cable branch and mid-span branch.

For the purpose of minimizing the causes of the splice loss during the process of splicing the optical fiber, the core axes of two optical fibers to be spliced should be precisely adjusted. In particular, when the optical fiber is set within the fusion splicer, the optical fiber should be correctly placed within a fixed V-groove. Also, when the cross section of the optical fiber is processed, the cross section should not be in an incomplete state due to alien substances or cutting. The embodiment of the present invention makes it a rule to splice the optical fibers of the same product. In exceptional cases, it is necessary to select two optical fibers whose difference between the structure parameters (MDF, refractive index contrast, etc) is minimum.

Hereafter, an exemplary embodiment of the present invention will be described in detail with reference to the accompanying drawings.

The fusion splicer having an added optical fiber inspection function (hereafter, referred to as fusion splicer 100) in accordance with the embodiment of the present invention includes: an adaptor 180 which is connected to an input terminal 1 of the optical fiber and receives light from an output terminal 2 of the optical fiber, wherein the input terminal 1 is fused to the optical fiber fusion splicer and has a fusion splicing part 3; and a controller 140 which is connected to the adaptor 180 and calculates an optical loss rate of the input terminal 1 of the optical fiber compared to an optical signal intensity of the output terminal 2 of the optical fiber.

The fusion splicer 100 further includes a monitor 150 which is connected to the controller 140 and displays the optical loss rate.

Also, the controller 140 stores previously a set loss rate based on the length from the input terminal 1 to the output terminal 2 of the optical fiber and further includes a function to determine that the fusion splicing is successful when the optical loss rate is higher than the set loss rate and to determine that the fusion splicing is poor when the optical loss rate is less than the set loss rate. The monitor 150 displays the successful splicing or poor splicing according to the determination of the controller 140.

Also, the fusion splicer 100 further includes a light source 190 which is connected to the input terminal 1 of the optical fiber and supplies light to the output terminal 2 of the optical fiber, wherein the input terminal 1 is fused to the optical fiber fusion splicer and has the fusion splicing part 3, thereby determining with the naked eye whether the splicing is poor or not.

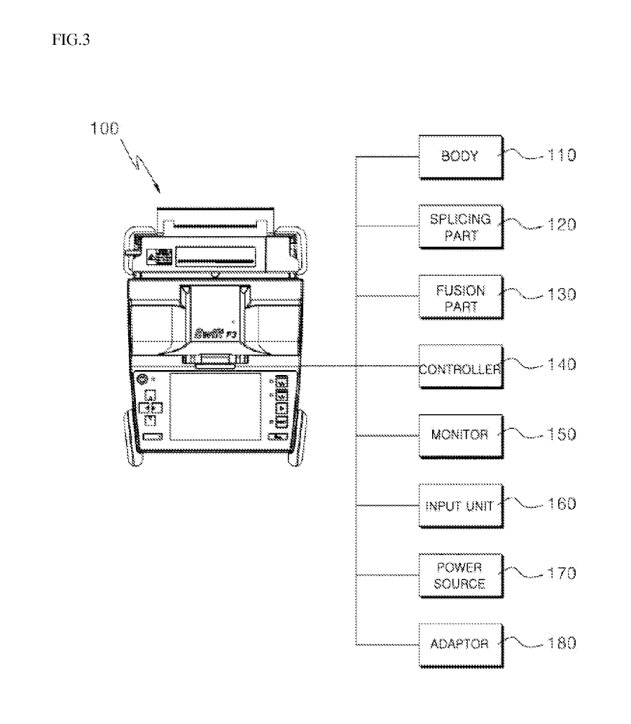

Specifically, FIG. 3 is a schematic view of the fusion splicer 100 according to the embodiment of the present invention. The fusion splicer 100 of FIG. 3 includes a body 110, a splicing part 120, a fusion part 130, the controller 140, the monitor 150, an input unit 160, a power source 170, and the adaptor 180.

The body 110 is a kind of case. The body 110 embeds and protects each of the components constituting the fusion splicer 100 or mounts on the surface thereof. The splicing part 120 splices the optical fiber. The fusion part 130 fuses a reinforcing sleeve inserted into the spliced optical fiber. The input unit 160 operates the electrical components out of the components constituting the fusion splicer 100. The power source 170 applies electric power to the electrical components out of the components constituting the fusion splicer 100.

Such components are essential to the known fusion splicer. The detailed description thereof will be omitted.

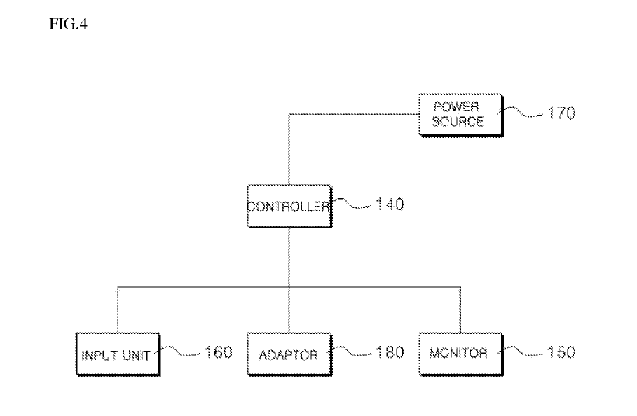

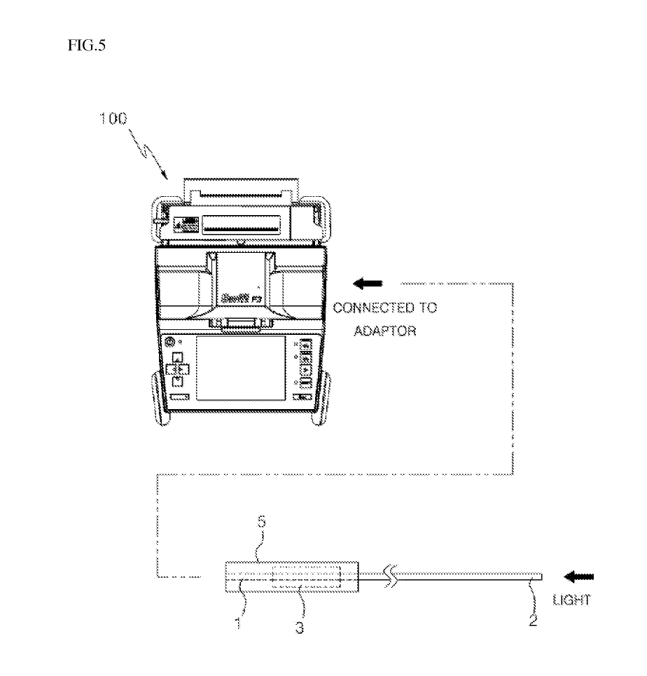

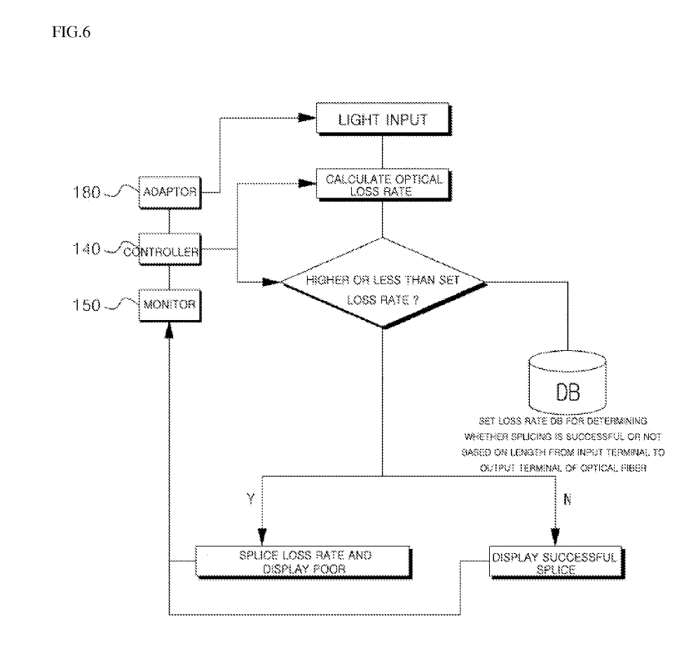

Meanwhile, the controller 140, monitor 150, input unit 160, power source 170, and adaptor 180 are main parts of the fusion splicer 100 according to the embodiment of the present invention and have a connection relationship shown in FIG. 4.

The adaptor 180 is connected to an optical fiber connector 5, i.e., the input terminal 1 of the optical fiber, which is spliced and fused by the splicing part 120 and fusion part 130 of the fusion splicer 100 and has the fusion splicing part 3, and receives light from the output terminal 2 of the optical fiber. The adaptor 180 has the same structure as that of the adaptor of the power meter 300. The adaptor 180 can be installed anywhere in the fusion splicer 100, for example, the side, front, etc., of the fusion splicer 100.

The adaptor 180 is connected to the controller 140 and transmits the intensity of the input optical signal to the controller 140.

The controller 140 controls the configuration of the splicing part 120, fusion part 130, etc., and calculates an optical loss rate of the input terminal 1 of the optical fiber compared to the optical signal intensity of the output terminal 2 of the optical fiber on the basis of the intensity of the optical signal which is input from the adaptor 180. Here, the optical signal intensity of the output terminal 2 may be stored in advance. That is, the controller 140 is aware of the optical signal intensity of the output terminal 2 of the optical fiber by using the optical signal intensity of the output terminal 2 of the optical fiber, which has been previously stored in a database (DB), and the set loss rate which is based on the length of the optical fiber and appears on the input terminal 1 of the optical fiber, so that the controller 140 is able to measure the loss rate by comparing the optical signal intensity of the input terminal 1. It is possible to determine that the fusion splicing is poor or successful by comparing the measured loss rate with the previously stored set loss rate. Also, the monitor 150 displays the measured loss rate and may display the successful splicing or poor splicing.

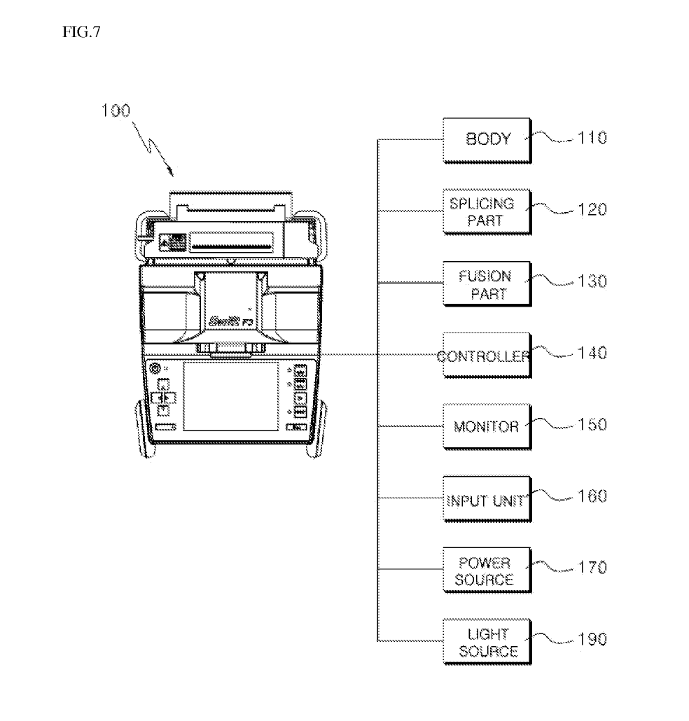

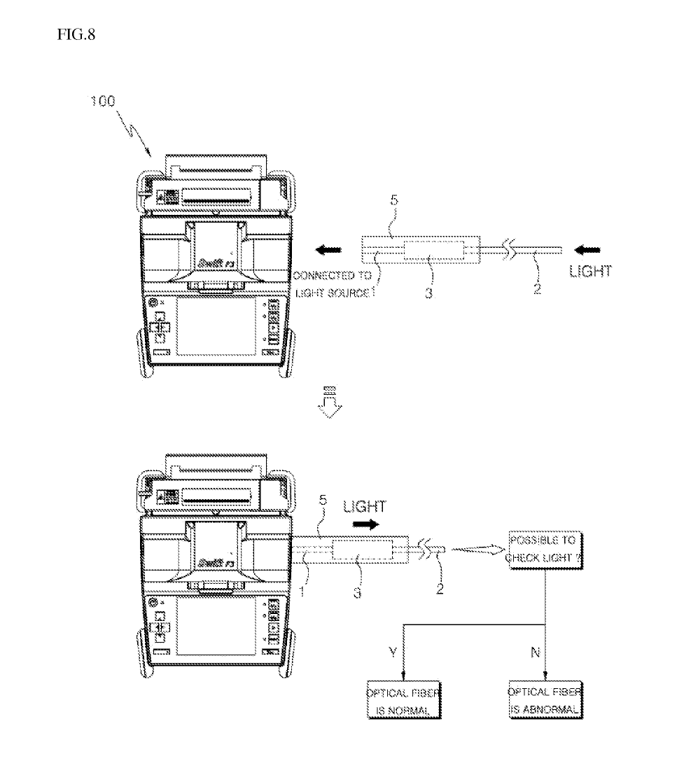

Meanwhile, the fusion splicer 100 according to another embodiment of the present invention includes the light source 190 together with the configuration of the above-described fusion splicer 100 according to the embodiment. Otherwise, as shown in FIGS. 7 and 8, the light source 190 is included in the fusion splicer 100.

The light source 190 includes an LED irradiating the light and allows the optical fiber connector to be inserted thereinto. The light source 190 may be installed on various positions, for example, the front, side, etc., of the body 110 of the fusion splicer 100. The light source 190 is connected to the controller 140, input unit 160, and power source 170.

When the optical fiber connector 5 is, as shown in FIG. 8, connected to the light source 190, the electric power of the power source 170 is applied through the controller 140 by pressing a button of the input terminal 160, so that the light is irradiated to the optical fiber connector. When it is checked with the naked eye that the irradiated light is emitted from the optical fiber output terminal 2, it is determined that the optical fiber is normal, and when it is checked with the naked eye that the light is emitted from the optical fiber connector 5 or a middle portion instead of the optical fiber output terminal 2, it is determined that the optical fiber is abnormal.

While the exemplary embodiments of the present invention has been described, various changes and modifications of the embodiments can be easily made without departing from the essential features of the present invention by those skilled in the art. Therefore, the disclosed embodiments are merely exemplary and are not to be construed as limiting the present invention. The true scope of the present invention is shown in the appended claims and not in the foregoing descriptions. It should be construed that all differences within the scope equivalent to that of the claims are included in the present invention.

### REFERENCE NUMERALS

1: input terminal

2: output terminal

3: fusion splicing unit

5: optical fiber connector

100: fusion splicer

140: controller

150: monitor

180: adaptor

190: light source

1. A fusion splicer having an added optical fiber inspection function comprises:
an adaptor 180 which is connected to an input terminal 1 of the optical fiber and receives light from an output terminal 2 of the optical fiber, wherein the input terminal 1 is fused to an optical fiber fusion splicer and has a fusion splicing part 3; and
a controller 140 which is connected to the adaptor 180 and calculates an optical loss rate of the input terminal 1 of the optical fiber compared to an optical signal intensity of the output terminal 2 of the optical fiber.

2. The fusion splicer having an added optical fiber inspection function of claim 1, further comprising a monitor 150 which is connected to the controller 140 and displays the optical loss rate.

3. The fusion splicer having an added optical fiber inspection function of claim 1, wherein the controller 140 stores previously a set loss rate based on the length from the input terminal 1 to the output terminal 2 of the optical fiber and further comprises a function to determine that the fusion splicing is successful when the optical loss rate is higher than the set loss rate and to determine that the fusion splicing is poor when the optical loss rate is less than the set loss rate, and wherein the monitor 150 displays the successful splicing or poor splicing according to the determination of the controller 140.

4. A fusion splicer having an added optical fiber inspection function comprises a light source 190 which is connected to an input terminal 1 of the optical fiber and supplies light to an output terminal 2 of the optical fiber, wherein the input terminal 1 is fused to the optical fiber fusion splicer and has a fusion splicing part 3, thereby determining with the naked eye whether the splicing is poor or not.
